(19) United States
(12) Patent Application Publication
(10) Pub. No.: US 2019/0143592 A1
(43) Pub. Date: May 16, 2019

(54) A TABLE SYSTEM FOR AN ADDITIVE MANUFACTURING MACHINERY FOR PLASTIC COMPONENTS

(71) Applicant: BLB INDUSTRIES AB, Värnamo (SE)

(72) Inventors: Thomas BURMAN, Värnamo (SE); Cim BERGDAHL, Falköping (SE); Jacob LUNDIN, Värnamo (SE); Anders ALRUTZ, Växjö (SE); Clas JANSSON, Värnamo (SE)

(21) Appl. No.: 16/300,058

(22) PCT Filed: May 5, 2017
(86) PCT No.: PCT/SE2017/050446

§ 371 Date: Nov. 8, 2018

(30) Foreign Application Priority Data
May 9, 2016 (SE) 1650623-0

(51) Int. Cl. B29C 64/245; B33Y 30/00; B33Y 50/02; B29C 64/393

(52) U.S. Cl. CPC B29C 64/245; B29C 64/393; B33Y 50/02; B33Y 30/00

(57) ABSTRACT

A table system for an additive manufacturing machinery (1). The system (1) comprising a table top (2), a heating mat (4) for heating the table top (2), and a vacuum providing unit (5) providing negative pressure to the table top (2) in order to hold at least one intermediate layer (6) flat towards the table top (2). The table top (2) is divided into a first (7) and a second table top sub part (8), and the at least one intermediate layer (6) is to be provided onto the table top (2), and the vacuum providing unit (5) is arranged to control the negative pressure provided to the first (7) and the second table top sub part (8) so that the negative pressure provided to the first table top sub part (7) is controlled independently of the pressure provided to the second table top sub part (8).

### TECHNICAL FIELD

The present invention relates to a table system for an additive manufacturing machinery for plastic components.

### BACKGROUND

The additive manufacturing machinery of today is most often designed to produce a limited amount of material at a time. This also applies to the additive manufacturing machinery for plastic components. Furthermore, the needs in the manufacturing industry, and in the plastic industry in particular, will in the future be to more swiftly be able to produce larger components but also to be able to produce different type of components in parallel.

There are however certain limitations in the additive manufacturing machinery of today which constitute obstacles for faster production of larger and more diverse components.

Concerning diverseness, the components produced in parallel in a machine should ideally be given less constraints with regards to size, production time needed and the specific material to be used for each component.

To manufacture plastic components to perfection in an additive manufacturing machinery has proved to be difficult. This is due to the fact that the plastic has a tendency to shrink too much when it is heated.

To hold the plastic component, which is being produced, in place during the production phase could furthermore be rather problematic in an additive manufacturing machine. For instance if the printhead hits the plastic component, the plastic component could be misplaced in the machine. This could of course result in that the plastic component is deformed during production.

Certain techniques have been developed in order for the plastic components to be held in place during production in different small additive manufacturing machinery equipment. For instance using an intermediate layer of some sort placed in between the table top and the component to be manufactured has been tried. The intermediate layer is then kept in place onto the table top by for instance applying glue in between the intermediate layer and the table top. These type of intermediate layers have most often been a mirror or a plate of glass. Other solutions have been to use clamps or clips to hold the intermediate layer in place.

Furthermore, on the surface of the mirror/plate of glass some sort of substance for increasing the adhesiveness between the intermediate layer and the plastic to be printed have been often applied. This could for instance be a thick fluid, an adhesive tape, glue or even hairspray. Applying this sort of substance for increased adhesiveness is of course a production step which ideally should be eliminated. Furthermore, if the intermediate layer could provide additional advantages it would also be desirable.

It therefore exists a need for a vacuum table for an additive manufacturing machinery for plastic components, which supports the objective that a component or components produced in parallel in one additive manufacturing machinery should be given less constraints with regards to size, production time needed and the specific material to be used for each component. A unit which holds the plastic component to be produced in place during production, should also be developed/improved. Decreasing the preparation time for an intermediate layer, placed in between the table top and the component to be produced, is also desirable. Other advantages with an improved intermediate layer would also be positive. To improve the production capability of plastic components using additive manufacturing machinery, and more specifically to just after printing decrease the shrinking of these plastic components is desirable.

### SUMMARY OF INVENTION

An objective of the present invention is thus to accomplish a table system for an additive manufacturing machinery for plastic components that provides or improves the possibility to in parallel in the same additive manufacturing machinery produce components in different sizes, with different requirements in production time and in different plastic materials, and that provides a developed/improved unit which holds the plastic component to be produced in place during production, and that provides the possibility to decrease the preparation time for an intermediate layer which is placed in between the table top and the component to be produced, and to improve the production capability of plastic components and more specifically to just after printing decrease the shrinking of these plastic components.

According to one aspect, the invention concerns a table system for an additive manufacturing machinery for plastic components comprising a table top, a table top support structure for supporting the table top, a heating mat mounted to the table top for heating the table top, and a vacuum providing unit providing negative pressure to the table top in order to hold at least one intermediate layer flat towards the table top. Wherein the table top is divided into a first and a second table top sub part onto which the at least one intermediate layer is to be provided, and the vacuum providing unit is arranged to control the negative pressure provided to the first and the second table top sub part so that the negative pressure provided to the first table top sub part is controlled independently of the pressure provided to the second table top sub part.

An advantage with the solution, is that it provides a developed/improved unit which holds the plastic component to be produced in place during production. The solution also implies that several and different intermediate layers can be applied to the table top. For a specific plastic component to be manufactured an intermediate layer with matching requirements, with regards for instance to the plastic type and the specific temperature interval for good adhesiveness between the intermediate layer and the plastic to be printed, can be applied to one table top sup part. The manufacturing can then subsequently be initiated. These intermediate layers can also have different requirements with regards to the negative pressure to be applied. Furthermore the negative pressure for the different intermediate layers placed on the different table top sub parts can be activated or inactivated via the vacuum providing unit. This implies that when a plastic component is finalised in the additive manufacturing machinery this specific component can be taken out and the manufacturing of the remaining plastic components can then continue. This provides the possibility to in parallel and in the same additive manufacturing machinery manufacture different plastic components in different sizes and consequently with different requirements in production time. Furthermore by having a heating mat mounted to the table top for heating the table top, the table top will transmit a suitable amount of heat to the plastic being printed via the intermediate layer while the plastic is printed upon the intermediate layer. The heating mat can obviously also transmit heat to the printed plastic after the manufacturing/printing process has stopped. Subsequently the plastic component will shrink less just after being printed, as it will be allowed to be cooled off slower.

The above system may be configured according to different optional embodiments. For example, the system may comprise at least one intermediate layer. Wherein the at least one intermediate layer may comprise at least one plastic print substrate. Wherein the at least one plastic print substrate may be similar to the plastic to be printed upon the plastic print substrate.

An advantage with the solution, is by comprising at least one intermediate layer, wherein the at least one intermediate layer may comprise at least one plastic print substrate, is that the plastic print substrate will provide better adhesiveness between this intermediate layer and the plastic to be printed than a mirror or a plate of glass on its own. The plastic print substrate should be able to replace both the intermediate layer, such as a mirror or a plate of glass, and the added substance for increased adhesiveness, such as a thick fluid, an adhesive tape, glue or hairspray. Using a plastic print substrate as an intermediate layer will subsequently decrease the preparation time for the intermediate layer which is placed in between the table top and the component to be produced. Further, having a plastic print substrate which is similar to the plastic to be printed upon the plastic print substrate, will provide the possibility for the intermediate layer to be integrated in the plastic component which is to be printed. This means that the intermediate layer will be an integral part of the manufactured component, and that a separation of the intermediate layer from the printed plastic component is not needed. Furthermore, the plastic print substrate, which is to be integrated into the printed plastic component, may have a specific surface facing the table top, which provides e.g. frictional and/or visual advantages to the end product/plastic component.

According to an embodiment of the invention, the vacuum providing unit may comprise a switch operable by an operator for manually switching on and off the pressure to the first and the second table top sub part.

An advantage with the solution, by having the vacuum providing unit comprising a switch operable by an operator for manually switching on and off the pressure to the first and the second table top sub part, a plastic component which has been finalised can easily be taken out of the additive manufacturing machinery while the rest of the plastic components in the machinery can stay for being finalised. This is due to the fact that the negative pressure can manually for instance be turned off for a table top sup part corresponding to a specific plastic component which is finalised. The finalised plastic component can then be replaced by an intermediate layer, the negative pressure can once again be activated for that specific table top sub part/intermediate layer and the production of a new plastic component on this intermediate layer can be initiated.

According to an embodiment, the vacuum providing unit may be arranged to control the negative pressure to the first and the second table top to be under 7 bar and more preferably to be in the interval of 1.5-5 bar and most preferably to be approximately 4 bar.

An advantage with this solution, is that the intermediate layers/plastic print substrates which is applied on top of the table top will at these negative pressures be held firmly towards the table top without being deformed. Different types of plastic print substrates can further require slightly different negative pressures, within the interval mentioned.

According to an embodiment, the table top support structure may comprise at least one support beam and a plurality of support rods. Wherein the support rods may connect the at least one support beam to the table top. And wherein the heating mat may comprise cut-outs corresponding to the support rods. And wherein the table top may be at least 15 millimetres thick.

An advantage with this solution, is that having a table top at least 15 millimetres thick, is that the thickness of the table top results in a higher dispersion of heat in the table top. The heat originates from the heating mat. A higher dispersion of heat subsequently solves the problem of not having any heating mat in connection with the support rods. If the thickness would be smaller there could otherwise be colder areas on top of the table top, which could result in e.g. shrinkage in the printed plastic components. Another advantage of having a thicker table top than 15 millimetres, is that such a table top can handle a higher weight compared to a thinner table top. The table top should be able to cope with at least 2 000 kg of printed plastic.

According to an embodiment, the heating mat may comprise a first and a second heating mat mounted to the table top for heating the table top. Wherein the table top may be divided into a first and a second table top heating zone. Wherein the first table top heating zone corresponds to the first table top sub part and the second table top heating zone corresponds to the second table top sub part. And wherein the first heating mat may be arranged to heat the first table top heating zone and the second heating mat may be arranged to heat the second table top heating zone.

An advantage with this solution, is that having different heating mats for different heating zones, the different intermediate layers on the different table top sub parts and the plastic printed upon these intermediate layers may be exposed to different levels of heat. This will minimise the risk for shrinkage of the different plastic components as the different plastics reacts differently to heat. The different plastic print substrates will also react differently to heat, and there is a specific optimal temperature for each plastic print substrate with regards of the adhesiveness towards the plastic printed upon it. The temperature for optimal adhesiveness can therefore be set for each different plastic print substrate due to the function described.

According to an embodiment, the system may comprise at least one temperature sensor connected to the table top. Wherein the at least one temperature sensor may be arranged to collect temperature data from the table top. And wherein a vacuum table control unit may be arranged to receive the temperature data and to control the temperature of the heating mat in response to the collected temperature data.

An advantage with this solution, is that having at least one temperature sensor the actual temperature of the table top can be measured and controlled more accurately. Thus different intermediate layers and the plastic printed upon these intermediate layers may be exposed to different levels of heat. This will even further minimise the risk for shrinkage of the different plastic components as the different plastics reacts differently to heat. Different plastic print substrates will also react differently to heat, and there is a specific optimal temperature for each plastic print substrate with regards of the adhesiveness towards the plastic printed upon it. The temperature for optimal adhesiveness can therefore be set even more accurate for each different plastic print substrate due to the function described.

According to an embodiment, the temperature sensor may comprise a first and a second temperature sensor. Wherein the first temperature sensor may be connected to the first table top heating zone for collecting temperature data. And wherein the second temperature sensor may be connected to the second table top heating zone for collecting temperature data. Wherein the vacuum table control unit may be arranged to receive the temperature data and to control the temperature of the first and second heating mat in response to the collected temperature data.

An advantage with this solution, by having a first temperature sensor connected to the first table top heating zone for collecting temperature data, and a second temperature sensor connected to the second table top heating zone for collecting temperature data, and a vacuum table control unit arranged to receive the temperature data and to control the temperature of the first and second heating mat in response to the collected temperature data, is that the actual temperature of the different table top heating zones can be measured and controlled more accurately. Thus different intermediate layers and the plastic printed upon these intermediate layers may be exposed to different levels of heat. This will even further minimise the risk for shrinkage of the different plastic components manufactured as the different plastics reacts differently to heat. Different plastic print substrates will also react differently to heat, and there is a specific optimal temperature for each plastic print substrate with regards of the adhesiveness towards the plastic printed upon it. The temperature for optimal adhesiveness can therefore be set even more accurate for each different plastic print substrate due to the function described.

According to an embodiment, the system may comprise at least one motor. Wherein the vacuum table control unit may be arranged to control the at least one motor for altering the height of the table top support structure and the table top.

An advantage with this solution, by comprising at least one motor, and wherein the vacuum table control unit is arranged to control the at least one motor, is that the height of the table top support structure and the table top can be altered. This will provide the possibility for a plurality of layers of plastic to be swiftly and efficiently printed on top of each other for creating large components within the additive manufacturing machinery.

The table top can be divided into more than two table top sub parts.

There can be more than two heating mats, and there can subsequently be more than two table top heating zones.

The first heating mat and the second heating mat can be adjusted to different temperatures. Having the ability to set different temperatures can be an advantage when there are different types of print substrates placed on the table top.

The table top may be made out of a material which conducts heat well. The table top can for instance be made out of aluminium.

The vacuum table control unit can be part of a machine control unit. The machine control unit may control all different aspects relating to the additive manufacturing machinery for plastic components.

All parts or some of the parts of the vacuum providing unit can be part of the vacuum table control unit.

The vacuum providing unit, sometimes also known as a vacuum venturi, can comprise components such as a compressor, a first tubing system connecting the compressor to a vacuum control unit which controls the negative pressure, a valve control system which controls the valves and the air flow to a second tubing system connected to the table top.

The compressor, the first tubing system and the vacuum control unit may be replaced by a unit known as a vacuum pump.

For each plastic print substrate that is to be held against the table top, an air flow of approximately 200 litres/minute is required.

The system may use plastic granules for the production of plastic components. The granules can be made of all different type of plastics.

The vacuum providing unit may comprise a second tubing system connected to the table top, which have a good resistance to heat, providing negative pressure to the table top.

The heating mat may comprise cut-outs corresponding to other components, apart from the support rods. These other components can for instance be the second tubing system which is connected to the table top.

The at least one intermediate layer may comprise at least one plastic print substrate.

The at least one plastic print substrate may comprise a polyethermide (PEI).

The plastic print substrate should reach and maintain a temperature of 30-210° C., preferably 90-110° C., before the additive manufacturing equipment has started to print out plastic on the plastic print substrate. The exact temperature for optimising the adhesiveness in between the intermediate layer and the plastic to be printed will though vary between different intermediate layers/print substrates and different plastics to be printed.

The system will also be able to handle plastics well which have a high melting point. Melting points around 300° C. will not be a problem for the system. This is due to the fact that the heating system provides controlled heat via the intermediate layer to the plastic to be printed, and the shrinkage of the plastic is then eliminated or at least kept to a minimum.

The vacuum providing unit, or the vacuum table control unit, or the machine control unit may comprise a functionality for automatically switching on and off the negative pressure to the first and the second table top sub part. These actions could be taken if a plastic component for instance is finalised or if a manufacturing process of a new plastic component is to be initiated.

The vacuum providing unit, or the vacuum table control unit, or the machine control unit may also comprise a functionality for automatically switching on and off the full additive manufacturing machinery when the vacuum providing unit receives a signal that there is no or too little negative pressure applied to a specific table top sub part/intermediate layer. If the machinery would not manually or automatically stop at such an event, the grip of the plastic component provided via the intermediate layer could have been lost and the plastic component could constitute a danger to the machinery equipment and/or the operators of the machinery.

### BRIEF DESCRIPTION OF DRAWINGS

The invention is now described, by way of example, with reference to the accompanying drawings, in which:

FIG. 1 shows a table system for an additive manufacturing machinery for plastic components in a front view, according to an embodiment of the invention, and

FIG. 2 shows a table system for an additive manufacturing machinery for plastic components in a view from above, wherein a pair of intermediate layers are placed on the table top, according to an embodiment of the invention, and

FIG. 3 shows a table system for an additive manufacturing machinery for plastic components in a view from below, wherein a first and a second heating mat are mounted to and under the table top, according to an embodiment of the invention, and

FIG. 4 shows a block diagram of parts of the system, according to an embodiment of the invention.

### DESCRIPTION OF EMBODIMENTS

In the following, a detailed description of a table system for an additive manufacturing machinery for plastic components is provided.

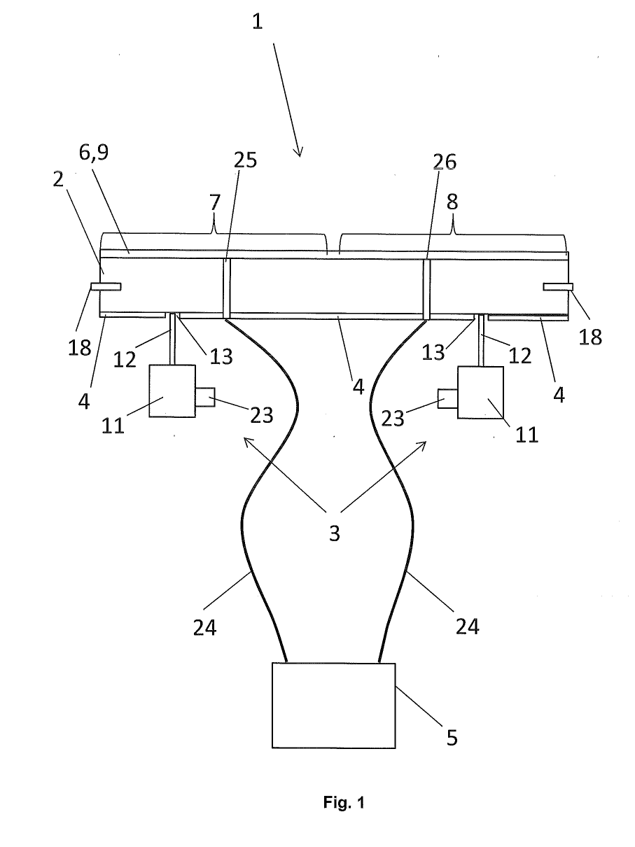

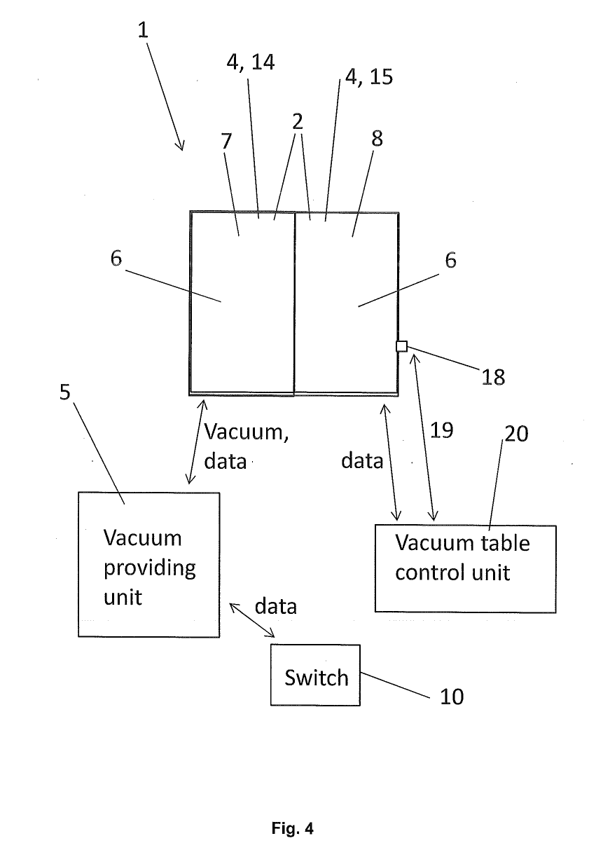

FIG. 1 shows a table system for an additive manufacturing machinery for plastic components 1 according to an embodiment of the invention, made up of a table top 2, a table top support structure 3 for supporting the table top 2, a heating mat 4 mounted to the table top 2 for heating the table top 2. The at least one intermediate layer 6 comprises at least one plastic print substrate 9. The at least one plastic print substrate 9 is similar to the plastic to be printed upon the plastic print substrate 9. The table top support structure 3 comprises at least one support beam 11 and a plurality of support rods 12. The support rods 12 connects the at least one support beam 11 to the table top 2. The heating mat 4 comprises cut-outs 13 corresponding to the support rods 12. The system 1 comprises at least one temperature sensor 18 connected to the table top 2. The system 1 comprises at least one motor 23. The vacuum table control unit 20 in FIG. 4 is arranged to control the at least one motor 23 for altering the height of the table top support structure 3 and the table top 2. The vacuum providing unit 5 can be arranged to control and provide, via a second tubing system 24 and further trough a first through hole 25 in the table top 2 the negative pressure to the first table top sub part 7, and via the second tubing system 24 and further through a second through hole 26 in the table top 2 the negative pressure to the second table top sub part 8, so that the negative pressure provided to the first table top sub part 7 is controlled independently of the pressure provided to the second table top sub part 8. There can also be more than two through holes in the table top 2 providing and controlling negative pressure to more than two table top sub parts.

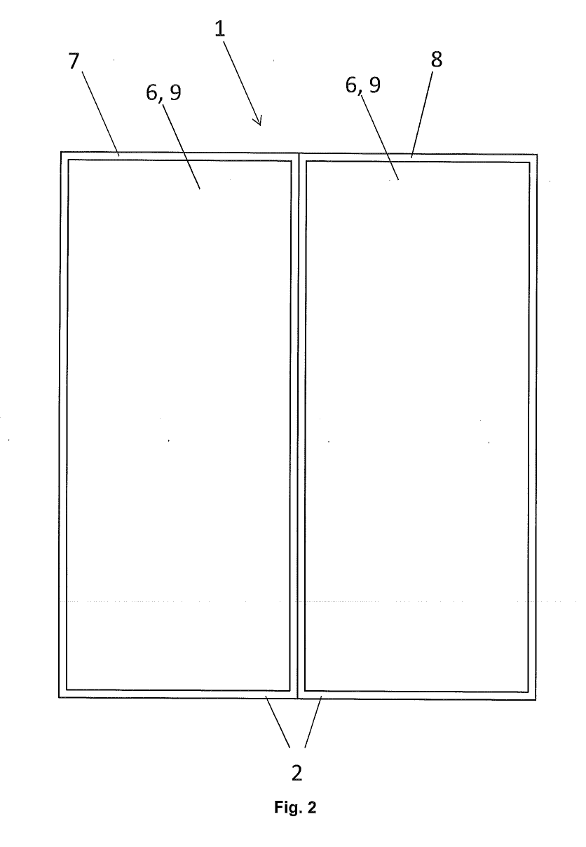

FIG. 2 shows the table system for an additive manufacturing machinery for plastic components 1 according to an embodiment of the invention, wherein the table top 2 can be divided into a first 7 and a second table top sub part 8 onto which the at least one intermediate layer 6 can be provided.

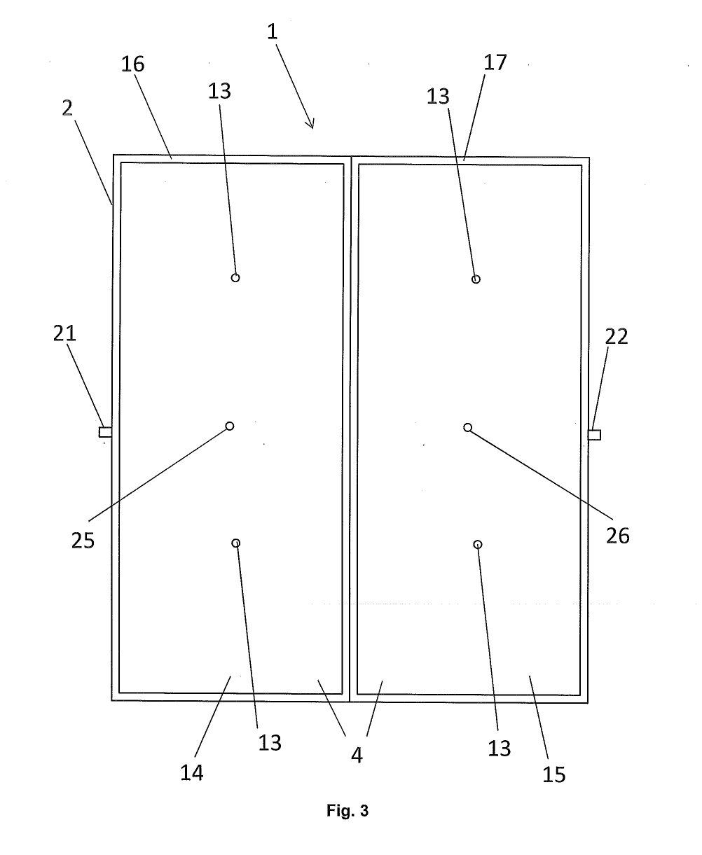

FIG. 3 shows the table system for an additive manufacturing machinery for plastic components 1 according to an embodiment of the invention. The heating mat 4 comprises a first 14 and a second heating mat 15 mounted to the table top 2 for heating the table top 2. The table top 2 is divided into a first 16 and a second table top heating zone 17. The first table top heating zone 16 corresponds to the first table top sub part 7 in FIG. 2 and the second table top heating zone 17 corresponds to the second table top sub part 8 in FIG. 2. The first heating mat 14 is arranged to heat the first table top heating zone 16 and the second heating mat 15 is arranged to heat the second table top heating zone 17. The temperature sensor 18 comprises a first 21 and a second temperature sensor 22. The first temperature sensor 21 is connected to the first table top heating zone 16 for collecting temperature data 19 see FIG. 4, and the second temperature sensor 22 is connected to the second table top heating zone 17 for collecting temperature data 19 see FIG. 4. The heating mat 4 comprises cut-outs 13 corresponding to the support rods 12 in FIG. 1.

FIG. 4 shows the table system for an additive manufacturing machinery for plastic components 1 according to an embodiment of the invention, comprising a vacuum providing unit 5 providing negative pressure to the table top 2 in order to hold at least one intermediate layer 6 flat towards the table top 2. The vacuum providing unit 5 is arranged to control the negative pressure provided to the first 7 and the second table top sub part 8 so that the negative pressure provided to the first table top sub part 7 is controlled independently of the pressure provided to the second table top sub part 8. The vacuum providing unit 5 comprises a switch 10 operable by an operator for manually switching on and off the pressure to the first 7 and the second table top sub part 8. The at least one temperature sensor 18 is arranged to collect temperature data 19 from the table top 2. A vacuum table control unit 20 can be arranged to receive the temperature data 19 and to control the temperature of the heating mat 4 in response to the collected temperature data 19. The vacuum table control unit 20 can be arranged to receive the temperature data 19 and to control the temperature of the first 14 and second heating mat 15 in response to the collected temperature data 19.

1. A table system for an additive manufacturing machinery for plastic components (1), the system (1) comprising a table top (2), a table top support structure (3) for supporting the table top (2), a heating mat (4) mounted to the table top (2) for heating the table top (2), and a vacuum providing unit (5) providing negative pressure to the table top (2) in order to hold at least one intermediate layer (6) flat towards the table top (2), wherein the table top (2) is divided into a first (7) and a second table top sub part (8), and the at least one intermediate layer (6) is to be provided onto the table top (2), and the vacuum providing unit (5) is arranged to control the negative pressure provided to the first (7) and the second table top sub part (8) so that the negative pressure provided to the first table top sub part (7) is controlled independently of the pressure provided to the second table top sub part (8).

2. A table system (1) according to claim 1, comprising at least one intermediate layer (6), wherein the at least one intermediate layer (6) comprises at least one plastic print substrate (9), wherein the at least one plastic print substrate (9) is similar to the plastic to be printed upon the plastic print substrate (9).

3. A table system (1) according to claim 1, wherein the vacuum providing unit (5) comprises a switch (10) operable by an operator for manually switching on and off the pressure to the first (7) and the second table top sub part (8).

4. A table system (1) according to claim 1, wherein the vacuum providing unit (5) is arranged to control the negative pressure to the first (7) and the second table top (8) to be under 7 bar and more preferably to be in the interval of 1.5-5 bar and most preferably to be approximately 4 bar.

5. A table system (1) according to claim 1, wherein the table top support structure (3) comprises at least one support beam (11) and a plurality of support rods (12), wherein the support rods (12) connects the at least one support beam (11) to the table top (2), and wherein the heating mat (4) comprises cut-outs (13) corresponding to the support rods (12), and wherein the table top (2) is at least 15 millimetres thick.

6. A table system (1) according to claim 1, wherein the heating mat (4) comprises a first (14) and a second heating mat (15) mounted to the table top (2) for heating the table top (2), wherein the table top (2) is divided into a first (16) and a second table top heating zone (17), wherein the first table top heating zone (16) corresponds to the first table top sub part (7) and the second table top heating zone (17) corresponds to the second table top sub part (8), and wherein the first heating mat (14) is arranged to heat the first table top heating zone (16) and the second heating mat (15) is arranged to heat the second table top heating zone (17).

7. A table system (1) according to claim 1, wherein the system (1) comprises at least one temperature sensor (18) connected to the table top (2), wherein the at least one temperature sensor (18) is arranged to collect temperature data (19) from the table top (2), and wherein a vacuum table control unit (20) is arranged to receive the temperature data (19) and to control the temperature of the heating mat (4) in response to the collected temperature data (19).

8. A table system (1) according to claim 6, wherein the temperature sensor (18) comprises a first (21) and a second temperature sensor (22), wherein the first temperature sensor (21) is connected to the first table top heating zone (16) for collecting temperature data (19), and wherein the second temperature sensor (22) is connected to the second table top heating zone (17) for collecting temperature data (19), and wherein the vacuum table control unit (20) is arranged to receive the temperature data (19) and to control the temperature of the first (14) and second heating mat (15) in response to the collected temperature data (19).

9. A table system (1) according to claim 1, wherein the system (1) comprises at least one motor (23), wherein the vacuum table control unit (20) is arranged to control the at least one motor (23) for altering the height of the table top support structure (3) and the table top (2).
